(19) United States
(12) Patent Application Publication
(10) Pub. No.: US 2020/0245777 A1
(43) Pub. Date: Aug. 6, 2020

(54) POCKETED SPRING UNIT AND METHOD AND APPARATUS FOR FORMING THE SAME

(71) Applicant: HS PRODUCTS LIMITED, Leeds, West Yorkshire (GB)

(72) Inventors: Simon SPINKS, Leeds, West Yorkshire (GB); David CLARE, Leeds, West Yorkshire (GB); Darren MARCANGELO, Leeds, West Yorkshire (GB); Richard ESSERY, Leeds, West Yorkshire (GB)

(21) Appl. No.: 16/637,302

(22) PCT Filed: Aug. 10, 2018
(86) PCT No.: PCT/GB2018/052279

§ 371 Date: Feb. 7, 2020

(30) Foreign Application Priority Data
Aug. 15, 2017 (GB) 1713098.0

(51) Int. Cl. A47C 27/06; A47C 27/07

(52) U.S. Cl. CPC A47C 27/064; B68G 9/00; A47C 27/07

(57) ABSTRACT

A pocketed spring unit comprises a plurality of strings of pocketed springs and a cover sheet, wherein each string comprises a flap of material located along an edge of the string and extending longitudinally of the string. The cover sheet is attached to the flaps at welds W.

The present invention relates to a pocketed spring unit and to a method and an apparatus for forming the same and is concerned particularly with a pocketed spring unit that is substantially free from adhesive, and to a method and apparatus for forming such a unit.

Pocketed springs, otherwise known as encased springs, are used in upholstered articles such as mattresses. Most pocketed spring units comprise coil springs encased individually in pockets of fabric material formed by folding over a sheet of fabric to form two leaves that envelope the springs, and then attaching the leaves together between the springs so as to form a string of springs. The strings are then joined to form an array of springs as a pocketed spring unit. The joining of the strings together to form an array is achieved either by gluing the strings together along the cylindrical surfaces of the pocketed springs, one string to the next, and so on until the unit is formed, or else by arranging the strings beside each other in the manner of an array, and then gluing sheets of fabric to the cylindrical ends of the pocketed springs, above and below, so as to form the unit.

A problem with either method is the extensive use of glue to hold together the strings, to form the unit. For one thing the adhesive forms a significant element of the cost of manufacturing a pocketed spring unit, and for another the presence of the adhesive in the product makes it difficult to recycle.

Embodiments of the present invention aim to provide a pocketed spring unit, and a method and apparatus for manufacturing the same, in which the shortcomings of the prior art are addressed.

The present invention is defined in the attached independent claims, to which reference should now be made. Further, preferred features may be found in the sub-claims appended thereto.

According to one aspect of the present invention, there is provided a pocketed spring unit comprising a plurality of strings of pocketed springs and a cover sheet, wherein each string comprises a flap of material located along an edge of the string and extending longitudinally of the string.

Preferably the flaps are arranged to fold such that the flap of one string is arranged to extend at least partly over an adjacent string.

The flaps are preferably formed of pocketing material and may be formed during a pocketing operation in which a sheet of pocketing material is folded over a plurality of springs, and then joined along its free edges and between adjacent springs.

Preferably the flap is arranged to extend over axial ends of the pocketed springs.

The flap is preferably joined to the cover sheet. Preferably the flap may be joined to the cover sheet by one or more welds.

The flap may be joined to at least one other flap from another string.

The cover sheet may be separate from the strings and may be joined to one or more of the flaps. Alternatively, the cover sheet may formed by the folded flaps.

The flaps may be joined to the cover sheet, or as the case may be to other flaps, by welds.

According to another aspect of the present invention, there is provided a method of forming a pocketed spring unit comprising a plurality of strings of pocketed springs, each having a flap of material located along an edge of the string and extending longitudinally of the string, and at least one cover sheet, the method comprising joining the strings to the unit by their flaps.

The flaps may be joined to the cover sheet. Alternatively, the flaps may be joined together to form the cover sheet.

The flaps may be joined to the cover sheet, or to each other by welding, which may comprise ultrasonic welding.

In a further aspect, the invention provides a computer programme product on a computer readable medium, comprising instructions that, when executed by a computer, cause the computer to perform a method according to any statement herein.

The invention also comprises a program for causing a device to perform a method according to any statement herein.

The invention may include any combination of the features or limitations referred to herein, except such a combination of features as are mutually exclusive, or mutually inconsistent.

A preferred embodiment of the present invention will now be described, by way of example only, with reference to the accompanying diagrammatic drawings, in which:

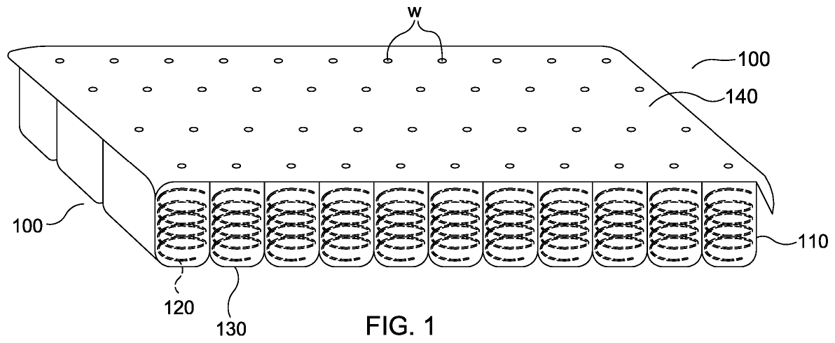

FIG. 1 shows schematically a pocketed spring unit according to an embodiment of the present invention;

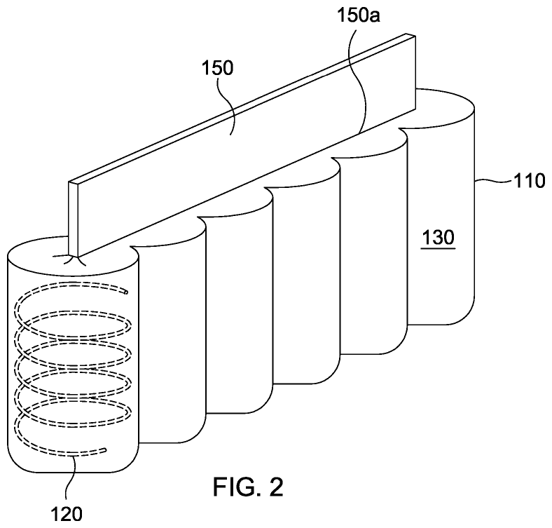

FIG. 2 shows in perspective view a part of a string of springs of the unit of FIG. 1;

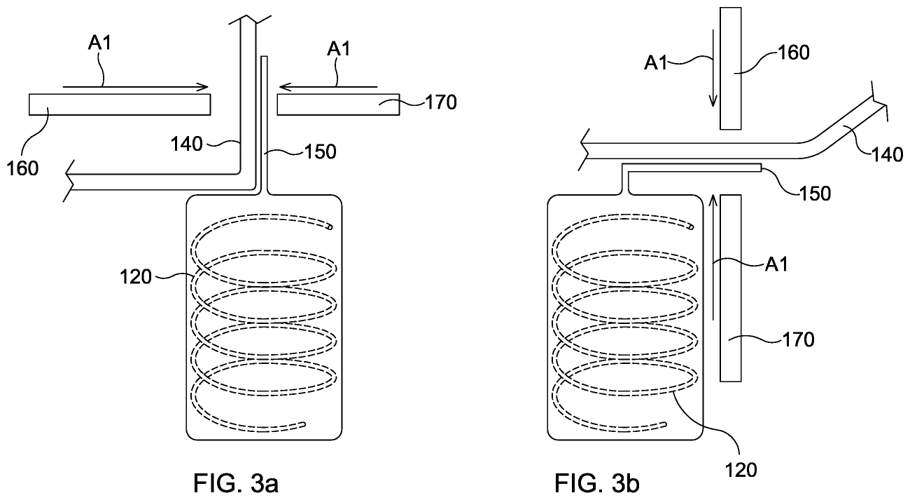

FIGS. 3a and 3b show alternative methods of welding the string of FIG. 2 to a cover sheet of the unit of FIG. 1, in accordance with a first embodiment of the invention;

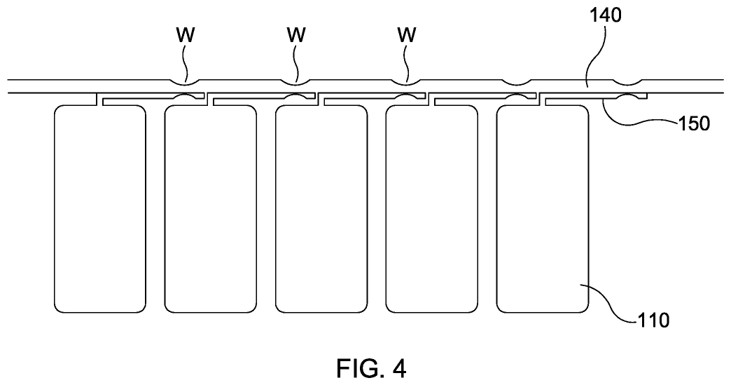

FIG. 4 shows schematically a string of springs joined to a cover sheet, in accordance with the first embodiment of the invention;

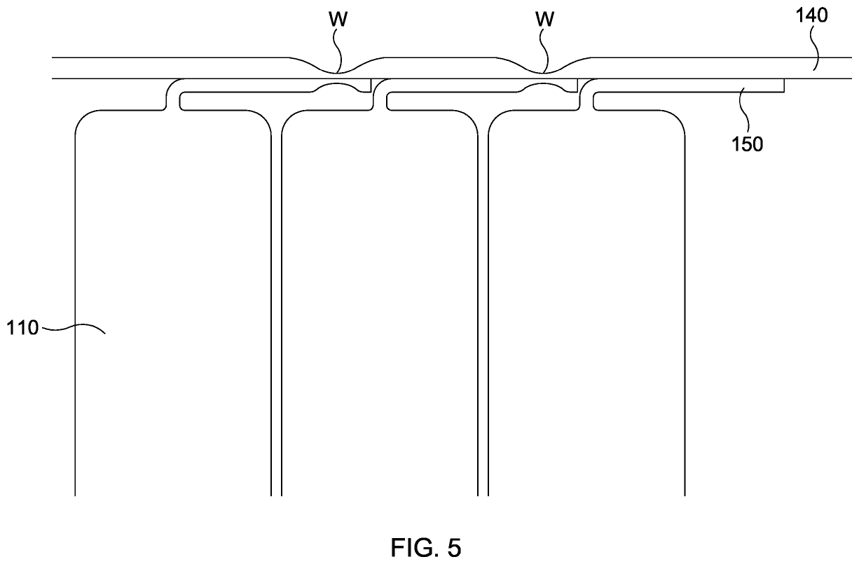

FIG. 5 is a more detailed view of the unit shown in FIG. 4; and

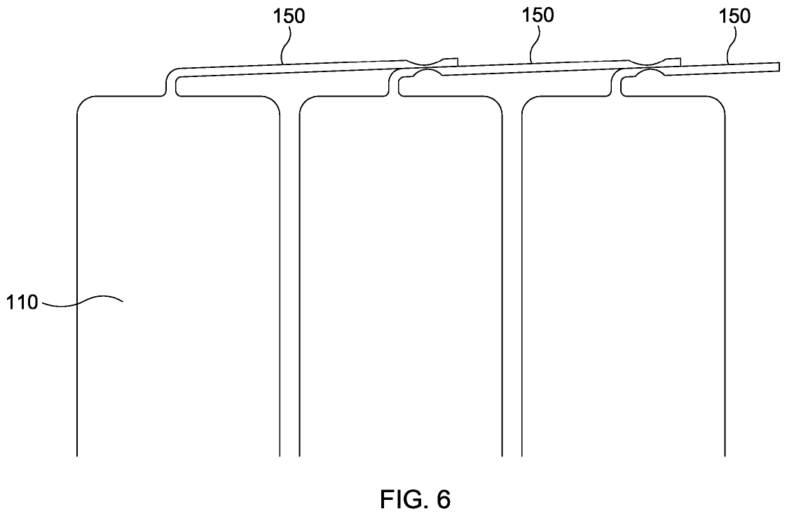

FIG. 6 shows a second embodiment of pocketed spring unit according to the invention.

Turning to FIGS. 1 and 2, these show, generally at 100, a pocketed spring unit such as may be used in, or as, a mattress or similar, in accordance with an embodiment of the present invention.

The pocketed spring unit 100 comprises a plurality of strings 110 of pocketed springs. Each string 110 comprises a number of wire coil springs 120, each located within its own discrete pocket of material 130. The material may be a weldable, nonwoven material, such as spun-bonded polyester. The strings are typically formed by folding a sheet of pocketing material over a plurality of springs and ultrasonically welding the sheet along its free edges and between the adjacent springs to produce a linear “string”.

The strings are each attached to a common cover sheet 140 at a number of welding locations W, by one of a number of methods, an example of which will be given below.

FIG. 2 shows part of a string 110 of springs prior to incorporation into the unit 100. The string comprises plural springs 120 encased in individual pockets formed of material 130. A continuous, longitudinal flap 150 of pocketing material extends along the top of the string 110. The flap was formed during the pocketing operation by welding a seam 150a along the material beyond the axial ends of the springs 120.

FIGS. 3a and 3b show alternative methods for joining the flap 150 to the cover sheet 140. In FIG. 3a, the flap 150 and sheet 140 are brought together with the flap 150 extending in a substantially axial direction with respect to the springs. First and second welding tools 160, 170 are brought together in the direction of arrows A1 to weld the flap 150 and the sheet 140 together.

FIG. 3b shows an alternative, in which the flap 150 is held in a folded configuration, substantially transverse to the axis of the springs, as it is welded to the sheet 140, again using welding tools 160, 170 which come together in the direction of arrows A1.

FIG. 4 shows schematically the unit in side view. Each of the flaps 150 is welded to the cover sheet 140, securely attaching the string to the cover sheet by welds W.

FIG. 5 is an enlarged view of the structure of FIG. 4, showing the uniformity of the welds W, which provides for a strong bond between the strings and the sheet, and hence a stable unit 100 overall.

FIG. 6 shows an alternative embodiment of unit 100 in which each flap 150 is welded directly to its immediate neighbor, so that the flaps themselves form the substantially continuous cover sheet 140.

It will be understood that the unit 100 may have a cover sheet at either one side of the unit or the other, or indeed that a cover sheet may be provided at both sides of the unit. In the case of a cover sheet being required at both sides of the unit, the strings will be formed with a flap at each axial end of the springs, and the welding operation will be adjusted accordingly.

The welding operation described above is preferably an ultrasonic welding method. However, alternative welding methods may be employed without departing from the scope of the invention.

Furthermore, whilst the example shown in the drawings is of a single flap located substantially centrally in the top end of the string, the flap could be positioned on the corner, such that it is substantially at the point where the circular end face of the pocket meets the cylindrical side surface of the pocket. There could be a flap at each side of the string, at the same end of the springs, and/or there could be a flap or flaps at both ends of the springs.

The flap shown in the example is two-ply—ie is made of two adjacent layers of the pocketing material. However, as an alternative, the flap could be a single web of material or else could be multiple layers. In addition, whilst a substantially continuous welded seam 150a defines the flap in the example of FIG. 2, the weld could be a discontinuous line, a pattern of dots or some other shape.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A pocketed spring unit comprising a plurality of strings of pocketed springs and a cover sheet, wherein each string comprises a flap of material located along an edge of the string and extending longitudinally of the string.

2. A unit according to claim 1, wherein the flaps are arranged to fold such that the flap of one string is arranged to extend at least partly over an adjacent string.

3. A unit according to claim 1, wherein the flaps are formed of pocketing material folded over a plurality of springs and joined along its free edges and at positions between adjacent springs.

4. A unit according to claim 1, wherein the flap is arranged to extend over axial ends of the pocketed springs.

5. A unit according to claim 1, wherein the flap is joined to the cover sheet.

6. A unit according to claim 5, wherein the flap is joined to the cover sheet by one or more welds.

7. A unit according to claim 1, wherein the flap is joined to at least one other flap from another string.

8. A unit according to claim 1, wherein the cover sheet is separate from the strings and is joined to one or more of the flaps.

9. A unit according to claim 1, wherein the cover sheet is formed by the folded flaps.

10. A unit according to claim 1, wherein the flaps are joined to the cover sheet, or as the case may be to other flaps, by welds.

11. A method of forming a pocketed spring unit comprising a plurality of strings of pocketed springs, each having a flap of material located along an edge of the string and extending longitudinally of the string, and at least one cover sheet, the method comprising joining the strings to the unit by their flaps.

12. A method according to claim 11, wherein the flaps are joined to the cover sheet.

13. A method according to claim 11, wherein the flaps are joined together to form the cover sheet.

14. A method according to claim 11, wherein the flaps are joined to the cover sheet, or to each other by welding.
